(19) United States
(12) Patent Application Publication
(10) Pub. No.: US 2022/0065451 A1
(43) Pub. Date: Mar. 3, 2022

(54) SOLAR POWERED PORTABLE LIGHTER

(71) Applicant: Justin Cortes, Manchester, CT (US)

(72) Inventor: Justin Cortes, Manchester, CT (US)

(21) Appl. No.: 17/400,219

(22) Filed: Aug. 12, 2021

Related U.S. Application Data
(60) Provisional application No. 63/071,587, filed on Aug. 28, 2020.

(51) Int. Cl. F23Q 7/16; H02J 7/35; H02J 7/00

(52) U.S. Cl. CPC F23Q 7/16; A24F 40/46; H02J 7/0044; H02J 7/35

(57) ABSTRACT

The present invention relates to a handheld solar powered electric lighter designed to create enough heat to selectively light a campfire, a cigarette and numerous other applications. The lighter includes a plurality of solar panels to absorb sunlight and convert same into electricity which is stored in an internal battery. At least one heating element capable of producing a flame using the electrical power stored in the internal battery. The lighter further includes LED lights along one or more surfaces which illuminate the lighter for use in low light areas, and a Type C USB charger for recharging an electronic device. An adjuster is present to lower or raise the at least one heating element for use, wherein the at least one heating element is raised by opening a hinged lid for easy accessibility.

### CROSS-REFERENCE TO RELATED APPLICATION

The present application claims priority to, and the benefit of, U.S. Provisional Application No. 63/071,587, which was filed on Aug. 28, 2020 and is incorporated herein by reference in its entirety.

### FIELD OF THE INVENTION

The present invention relates generally to the field of electric lighters. More specifically, the present invention relates to a solar powered electric handheld lighter that selectively enables ignition of a flame to light a campfire, and ignition of a coil to light a cigarette or the like. The solar powered electric handheld lighter features solar panels on one or more exterior surfaces, an internal battery to store electrical energy, a heating element to provide a flame, a push button to actuate the heating element, a heating element adjuster to lower and raise the heating element for access to a user, light emitting diodes (LEDs) to illuminate the exterior surfaces, a Type C USB charger and another heating element or cigarette lighter. The lighter provides a convenient, lightweight portable lighter device that provides a relatively strong flame, particularly suited for trekking, camping and other outside activities to use in almost any situation. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, people use cigarette lighters to light their cigarettes. Cigarette lighters create a relatively small heat source and generally use fuel or electricity to produce the heat. When going on a trek or while camping, individuals are able to light a cigarette or a piece of paper but may be unable to ignite something more substantial (i.e. charcoal or campfire) with typical standard cigarette lighters. Automobile lighters are also insufficient to produce a strong flame to fulfil user requirements. Further, in many circumstances, the user does not have access to alternative fuel sources, such as butane, to supply a lighter for maintaining a flame. Moreover, a cigarette can be lit using an automobile filament coil lighter, but the same lighter is not suitable to produce a flame. With little heat and an associated small flame, typical disposable lighters are not useful during windy days or under low light conditions.

Individuals can sometimes find themselves in need of lighting a campfire, charcoal or other similar items during treks or while camping. However, many times a source to light a strong flame is not available. Lighters typically require a resident fuel be present to ignite a flame, which may not always be accessible. Generally a flame is required to light wood, coal etc., and to provide illumination in the dark. Typical standard lighters do not provide the required heat and flame. People would prefer to have a lighter device that is always accessible to the user and that produces enough heat to generate a flame. Further, carrying fuel or dependency on a fuel for lighting a flame is also not desirable.

Therefore, there exists a long felt need in the art for a handheld lighter device to produce enough heat to light a flame, ignite charcoal or a campfire etc., but also provides a reduced heat source for lighting a cigarette. There is also a long felt need in the art for a handheld lighter device that does not require fuel to produce a flame. Additionally, there is a long felt need in the art for a handheld lighter device that does not cause pollution, and can be used in any variety of situations. Moreover, there is a long felt need in the art for a handheld lighter device that can be used in windy areas and low light areas. Further, there is a long felt need in the art for a handheld lighter device that stores energy automatically to produce a flame without requiring the user to replenish the fuel. Finally, there is a long felt need in the art for a handheld lighter device that is cost-effective, portable and offers an easier way of creating a relatively strong fire as needed in outside areas.

The subject matter disclosed and claimed herein, in one embodiment thereof, comprises a handheld solar powered electric lighter comprising: a plurality of solar panels on the exterior surfaces of the lighter; one or more internal batteries connected to the solar panels; solar energy captured by the solar panels is stored as electrical energy in the internal batteries; a pair of heating elements connected to the batteries via a circuitry wire; at least one of the heating elements receives electrical energy from the battery and heats up to ignite a flame for lighting when a push button is activated; and, an adjuster to lower or raise the heating element for use wherein the heating element is deployed by opening a hinged lid for easy accessibility. The lighter further includes LED lights along one or more surfaces to use in low light areas and a Type C USB charger capable of recharging an electronic device.

In this manner, the novel handheld lighter of the present invention accomplishes all of the forgoing objectives, and provides a solar energy-based lighter device that produces enough heat to create a flame and is environment friendly. The lighter is portable, lightweight, shockproof, rugged, durable and cost-effective. The lighter can be used in windy areas and low light areas. The lighter, in one potential embodiment, eliminates dependency on a fuel and can be used to selectively light campfires, charcoal, cigarettes and the like. The lighter further can charge an electronic device using the electrical energy converted from the captured solar energy.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld solar powered electric lighter comprising; a plurality of solar panels on the exterior surfaces of the lighter; one or more internal batteries connected to the solar panels; the solar energy captured by solar panels is stored as electrical energy in the internal batteries; a pair of heating elements connected to the batteries via a circuitry wire; at least one of the heating elements receives electrical energy from the battery and heats up to initiate a flame for lighting when a push button is activated; and, an adjuster to lower or raise the heating element for use wherein the heating element is deployed by opening a hinged lid for easy accessibility. The lighter further includes LED lights along one or more surfaces to use in low light areas and a Type C USB charger port to recharge an electronic device.

In a further embodiment of the present invention, a handheld solar powered portable lighter that enables lighting of a campfire, a cigarette or any other similar material is disclosed and comprises: a heating filament ball; a heating filament coil; a Type C USB charger port; an internal battery; a plurality of solar panels to capture solar energy; the internal battery stores the solar energy in the form of electrical energy; the electrical energy is provided to at least the heating filament coil to light a cigarette; the electrical energy is provided to at least the filament ball to initiate a flame to light a campfire; and, the electrical energy is provided to at least the Type C USB charger port to charge an electronic device. A push button is used to selectively activate the heating of the filament ball or the filament coil.

In one embodiment, the battery intelligently provides power selectively to the heating filament coil to the heating filament ball or the USB charger port. A cut-off switch can be integrated with the heating filament ball to stop power after a flame has been generated. The flame in the heating filament ball is generated after a spark in the filament is established.

The present invention provides users with a solar powered electric handheld lighter, useful to start or ignite campfires, light cigarettes, and more. The solar powered portable lighter is an effective and convenient lighter to use in almost any situation and can be used as a flashlight, a cigarette lighter, a fire starter or a charger.

The electric lighter of the present invention uses sunlight to charge an internal battery, which is then used to create heat and flame. The electric lighter is safer than traditional butane lighters, and in the long run more reliable and cost-effective. The electric lighter is useful for construction workers, winter sports enthusiasts or others who want a lighter that can be used in windy conditions or at high altitudes. Even fishermen may benefit from the device of the present invention as a backup lighter on a boat in case of emergencies.

The solar panels can be removable for a user to effectively eliminate any dust, flame debris or cigarette debris, thereby substantially extending the device's life. The color of the LEDs can be multicolor to increase the aesthetic appeal of the device. In one embodiment, the push button can adjust the flame to a suitable level. The lighter is perfect for igniting grills, lanterns, tiki torches and campfires. The flame of the device of the present invention is strong, and is not as soft as that of butane-powered lighters.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of the handheld solar powered electric lighter of the present invention in accordance with the disclosed architecture;

FIG. 2 illustrates a rear view of the handheld solar powered electric lighter of the present invention in accordance with the disclosed architecture;

FIG. 3 illustrates a perspective view of the handheld solar powered electric lighter of the present invention showing a heating element that can be used to light a campfire in an accessible position in accordance with the disclosed architecture;

FIG. 4 illustrates a perspective view of the bottom view of the solar powered portable lighter of the present invention having a bottle opener in accordance with the disclosed architecture; and

FIG. 5 illustrates a perspective view of the bottom view of another embodiment of the solar powered portable lighter of the present invention having a compass in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a handheld lighter device to produce enough heat to light a flame to ignite charcoal, campfires etc., we well as the ability to light a cigarette. There is also a long felt need in the art for a handheld lighter device that does not require fuel to produce a flame. Additionally, there is a long felt need in the art for a handheld lighter device that does not cause pollution and can be used in any situation. Moreover, there is a long felt need in the art for a handheld lighter device that can be used in windy areas and low light areas. Further, there is a long felt need in the art for a handheld lighter device that stores energy automatically to produce energy for a flame, without requiring the user to replenish the fuel. Finally, there is a long felt need in the art for a handheld lighter device that is cost-effective, portable and offers an easier way of creating a relatively strong flame as needed in outside areas.

The present invention, in one exemplary embodiment, is a handheld solar powered electric lighter comprising: a plurality of solar panels on the exterior surfaces of the lighter; one or more internal batteries connected to the solar panels; the solar energy captured by solar panels is stored as electrical energy in the internal batteries; a pair of heating elements connected to the batteries via a circuitry wire; at least one of the heating elements receives electrical energy from the battery and heats up to ignite a flame for lighting when a push button is activated; and, an adjuster to lower or raise the heating element for use wherein the heating element is raised by opening a hinged lid for easy accessibility. The lighter further includes LED lights along one or more surfaces to use in low light areas and a Type C USB charger (i.e. male port) to recharge an electronic device.

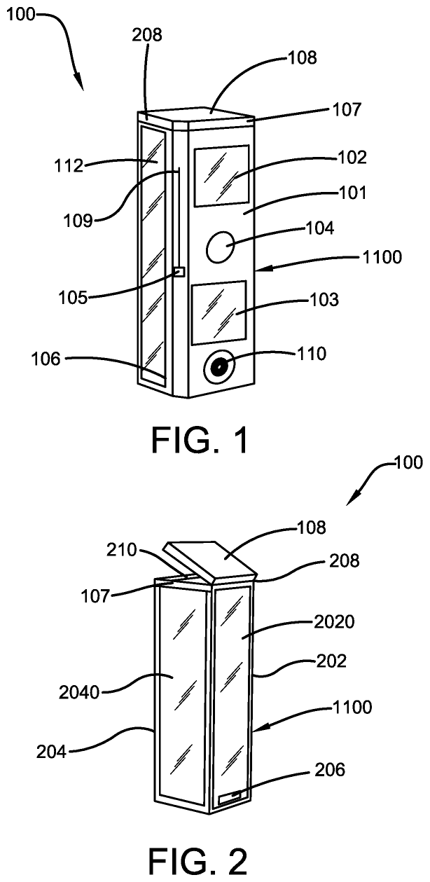

Referring initially to the drawings, FIG. 1 illustrates a front view of the handheld solar powered electric lighter of the present invention in accordance with the disclosed architecture. The handheld solar powered electric lighter 100 is a lightweight and portable lighter 100, designed to provide a flame for lighting a campfire, as well as to provide a heated coil for lighting a cigarette or the like. The lighter 100 creates more heat than a conventional lighter. The portable lighter 100 includes a cuboidal or rectilinear-shaped housing 1100, with a cavity that houses heating elements, an internal battery and circuitry to connect the components of the lighter 100. The front surface 101 includes a first solar panel 102 and a second solar panel 103 that are used to absorb solar energy to charge an internal battery of the portable lighter 100. A switch or push button 104 is present on the front surface 101 to selectively start heating a first heating element or filament coil (i.e. cigarette lighter) 110. The cigarette lighter 110, although recessed inside the cavity, can be accessed from the front surface 101, thus providing easy access for the user. The right side surface 106 includes a rectangular solar surface 112 along its length. The rectangular solar surface 112 also captures the solar energy and stores it in the form of electrical energy in the internal battery.

The housing is covered by a hinged lid 108 that is hinged 208 at one end and can be opened or closed to allow deployment of a second heating element or filament ball 302. Along the top edges of the front surface and right side surface 106, LEDs, or any other illumination source 107, can be mounted to provide illumination to some of the surfaces of the lighter 100, thereby allowing a user to easily locate the lighter 100 in low light areas. An adjuster 105 is accessible along one side of the lighter 100, and is connected to the second heating element 302 and provides a mechanism for raising and lowering the heating element 302.

To access the second heating element or filament ball 302 housed in the lighter 100, the adjuster 105 is actuated downward to raise the second heating element 302 from a top surface 301 of the housing 1100. Raising the second heating element 302 places the element in a deployed position for lighting a campfire or any other similar object. The filament ball adjuster 105 can be a hanging thread, a slide actuator or a pivot pin that is easily accessible to, and actuated by, a user. The internal battery can be a 4500 mAh capacity polymer battery that is easily recharged under sunlight using a plurality of solar panels 102, 103, 112, 2020, 2040 mounted to the exterior of housing 1100. The lighter 100 is ideal for selectively providing selectively two different levels and sources of heating elements 110, 302, each to be used depending upon the task at hand. In one embodiment, the lighter 100 includes a hook (not illustrated) that can be used to hang the lighter 100 to a backpack or the belt-loop of a trouser. The lighter 100 can be constructed with a waterproof, dustproof and shockproof housing.

FIG. 2 illustrates a rear view of the handheld solar powered electric lighter of the present invention in accordance with the disclosed architecture. A rear surface 202 includes a solar panel 2020 across the length of the rear surface 202 to absorb sunlight to recharge the internal battery. A Type C USB rapid charger 206 is present, proximal to the bottom of the rear surface 202, to recharge an electronic device. The Type C USB rapid charger 206 (i.e. male port) receives power from the internal battery. The left side surface 204 includes a solar panel 2040 across the length of the left side surface 204. The top edge of the left side surface 204 includes an illumination source 107.

The hinged lid 108 includes a hinge 208 across one edge, along which the lid 108 is opened. The lid is opened to access the cavity 210 from which the heating element 302 is accessed.

Each solar panel 102, 103, 112, 2020, 2040 includes one or more solar cells having a front surface for receiving sunlight and generating electrical energy, and a back surface that is attached to the surface of the housing 1100. Each solar panel 102, 103, 112, 2020, 2040 can be laminated by a transparent cover layer to protect the solar cell front surface. It is to be appreciated that the plurality of solar panels 102, 103, 112, 2020, 2040 comprise a solar panel area. The solar panel area comprises a majority of the housing side surface area. In one potential embodiment, the solar panel area is generally about 50 percent to about 80 percent of the housing side surface area. Maximum exposure of the solar panels is achieved when the lighter is placed in a vertical position. However, sufficient solar panel exposure to ambient light is achieved when the lighter 100 is placed in a horizontal position. It is to be appreciated that three sides of the housing and respective solar panels are exposed to ambient light when the lighter is placed in the horizontal position.

In one embodiment, a blocking diode may be inserted in the circuitry between the solar panel and the internal battery. The blocking diode prevents the draining of the internal battery by the solar panels when the solar cells are not generating sufficient voltage potential during periods of insufficient ambient light. The internal battery may, for example, be a 7.0V 700 mA lithium ion battery, a nickel cadmium battery, polymer battery, lithium polymer battery or other rechargeable battery.

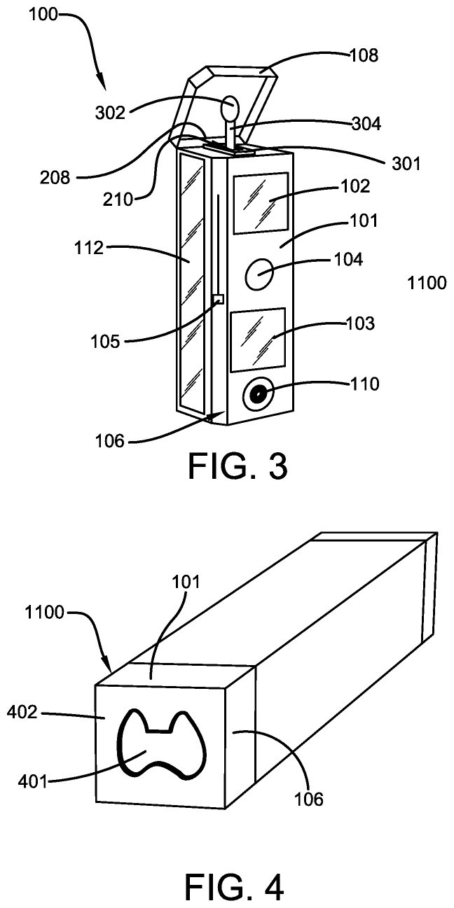

FIG. 3 illustrates a perspective view of the handheld solar powered electric lighter of the present invention, showing the second heating element 302 that can be used to light a campfire in the deployed position in accordance with the disclosed architecture. When the heating element adjuster 105 is pulled by a user, the heating element 302 slides up in the housing 1100 and opens the lid 108, such that the heating element or filament ball 302 becomes accessible. The push button 104, when pressed by the user, starts heating the filament ball 302 to create a flame. To lower the heating element 302 into the housing, the adjuster 105 is raised in an upward direction.

When the switch or push button 104 is selectively activated, power can be selectively applied to a heating wire 304 which in turn is connected to the heating element 302, which initiates heating of the filament ball 302 in order to start a flame. The lid 108 is automatically opened when the heating element or filament ball 302 is raised, and the lid 108 is automatically closed when the heating element or filament ball 302 is lowered. It is to be appreciated that when the second heating element 302 is deployed, the first heating element 110 (and the port 206) can be prohibited from actuation, thereby preventing a situation where both heating elements are simultaneously in the ON positions.

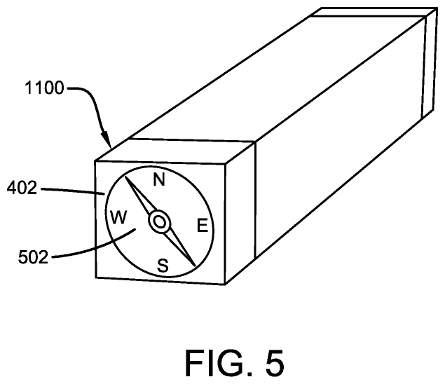

FIG. 4 illustrates a perspective view of the bottom view of the solar powered portable lighter of the present invention having a bottle opener in accordance with the disclosed architecture. As shown, in the present embodiment of the present invention, the bottom surface 402 includes a bottle opener 404 to increase the utility of the portable lighter 100 when going trekking or camping.

FIG. 5 illustrates a perspective view of the bottom view of another embodiment of the solar powered portable lighter of the present invention having a compass in accordance with the disclosed architecture. As shown, in the current embodiment of the present invention, the bottom surface 402 includes a navigational compass 502 to increase the utility of the portable lighter 100.

The lighter 100 conserves energy, is simple in structure, easy to use, lightweight and portable. The internal battery can be replaced easily by accessing the battery case from the bottom surface of the lighter 100. The outer surface of the lighter 100 can be insulated, and the heating element 302 can be quick to ignite after the push button 104 has been actuated.

The portable lighter 100 may have logos, indicia, trademarks, geometric patterns, customizable colors and fonts, embroidery and prints and/or images on the surface to alter the look of the lighter 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar powered portable lighter”, “electric lighter”, “handheld solar powered electric lighter”, “lighter” and “portable lighter”, are interchangeable and refer to the solar powered portable lighter 100 of the present invention.

Notwithstanding the forgoing, the solar powered portable lighter 100 and its components of the present invention can be of any suitable size and configuration as is known in the art without affecting the overall concept of the invention, provided that it accomplishes the above stated objectives. One of ordinary skill in the art will appreciate that the size, configuration, and material of the solar powered portable lighter 100 as shown in the FIGS. are for illustrative purposes only, and that many other sizes and shapes of the solar powered portable lighter 100 are well within the scope of the present disclosure. Although the dimensions of the solar powered portable lighter 100 are important design parameters for user convenience, the solar powered portable lighter 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What includes been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable rechargeable charger lighter comprising:
a rectilinear shaped housing having a hinged top;
a first heating element and a second heating element;
a battery;
a solar cell unit formed as a plurality of solar panels and being connected to said battery so as to electrically charge said battery;
said housing including a side surface total area and said plurality of solar panels including a combined area, wherein said combined area of said plurality of solar panels is generally about 50 percent to about 80 percent of said housing side surface total area;
a port to dispense charge to other devices;
circuitry capable of harnessing charge from said plurality of solar panels, as well as, dispensing charge; and
wherein all components, through said circuitry, are connected to the battery to permit said first heating element, said second heating element, and said port to be selectively powered through solar power stored in said battery.

2. The rechargeable charger lighter according to claim 1, wherein said first heating element is a filament coil to ignite a cigarette.

3. The rechargeable charger lighter according to claim 2, wherein said second heating element is a filament ball capable of igniting a flame for lighting a product proximal thereto.

4. The rechargeable charger lighter according to claim 3, wherein said port is a male port.

5. The rechargeable charger lighter according to claim 4, further comprising a compass.

6. The rechargeable charger lighter according to claim 5, further comprising a bottle opener.

7. The rechargeable charger lighter according to claim 6, further comprising an LED light.

8. The rechargeable charger lighter according to claim 3, wherein said hinged top covers said second heating element.

9. The rechargeable charger lighter according to claim 8, further comprising an actuator for deploying said second heating element and adjusting the height of said second heating element.

10. A portable rechargeable lighter comprising:
a rectilinear shaped housing having a hinged top;
a first heating element and a second heating element;
a battery;
a solar cell unit formed as a plurality of solar panels and being connected to said battery so as to electrically charge said battery;
a switch for selectively actuating said first heating element or said second heating element;
a circuitry capable of harnessing charge from said plurality of solar panels, as well as, dispensing charge;
wherein all components, through said circuitry, are connected to the battery to permit said first heating element or said second heating element to be selectively powered through solar power stored in said battery.

11. The rechargeable lighter according to claim 10, wherein said first heating element is a filament coil to ignite a cigarette.

12. The rechargeable lighter according to claim 11, wherein said second heating element is a filament ball capable of igniting a flame for lighting a product proximal thereto.

13. The rechargeable lighter according to claim 12, further comprising a port to dispense a charge to other devices wherein said port is a male port.

14. The rechargeable lighter according to claim 13, further comprising a compass.

15. The rechargeable lighter according to claim 14, further comprising a bottle opener.

16. The rechargeable lighter according to claim 15, further comprising an LED light.

17. The rechargeable lighter according to claim 12, wherein said hinged top covers said second heating element.

18. The rechargeable lighter according to claim 17, further comprising an actuator for deploying said second heating element and adjusting a height of said second heating element.

19. The rechargeable according to claim 11, wherein said housing including a side surface total area and said plurality of solar panels including a combined area,

20. The rechargeable according to claim 19, wherein said combined area of said plurality of solar panels is generally about 50 percent to about 80 percent of said housing side surface total area.
